(19) United States
(12) Patent Application Publication
(10) Pub. No.: US 2012/0323536 A1
(43) Pub. Date: Dec. 20, 2012

(54) Methods and systems for applying mass scaling in finite element analysis

(75) Inventor: Thomas Borrvall, Linkoping (SE)

(73) Assignee: LIVERMORE SOFTWARE TECHNOLOGY CORP, Livermore, CA (US)

(21) Appl. No.: 13/597,525

(22) Filed: Aug. 29, 2012

Related U.S. Application Data
(63) Continuation-in-part of application No. 12/435,561, filed on May 5, 2009.
Application No. 12/435,561 is a continuation-in-part of application No. 11/456,265, filed on Jul. 10, 2006, now abandoned.
(60) Provisional application No. 60/805,967, filed on Jun. 27, 2006.

(51) Int. Cl. G06F 17/50; G06F 17/10

(52) U.S. Cl. 703/1

(57) ABSTRACT

Methods and systems for applying mass scaling in finite element analysis is described. Elements with a critical time step smaller than a user desired time step are identified. Out of these elements, elements located in a particular region requiring realistic simulated dynamic responses are processed with selective mass scaling and the rest are processed with regular mass scaling. Selective mass scaling requires more computation but can better preserve dynamic structural characteristics. The aforementioned method is referred to as a mixed mode mass scaling. Mixed mode mass scaling allows engineering simulation to be conducted within a reasonable turnaround time, because only a portion of the FEA model is subjected to more computation intensive selective mass scaling. Selective mass scaling technique includes reducing effects caused in three translational and three rotational rigid body modes of shell element.

### CROSS-REFERENCE TO RELATED APPLICATION

This application is a continuation-in-part (CIP) of a co-pending U.S. patent application Ser. No. 12/435,561 for “Methods and systems for applying selective mass scaling in finite element analysis” filed on May 5, 2009, which is a CIP of U.S. patent application Ser. No. 11/456,265 for “Method and system for applying selective mass scaling in finite element analysis” filed on Jul. 10, 2006, which claims priority from a U.S. Provisional Patent Application Ser. No. 60/805,967 for “Method and system for applying selective mass scaling in finite element analysis” filed on Jun. 27, 2006.

### FIELD OF THE INVENTION

The present invention generally relates to computer-aided engineering analysis, more particularly to improved technique of applying mass scaling in finite element analysis that can be used for numerically simulating structural behaviors of a product (e.g., automobile, airplane, etc.).

### BACKGROUND OF THE INVENTION

Finite element analysis (FEA) is a computerized method widely used in industry to model and solve engineering problems relating to complex systems such as three-dimensional non-linear structural design and analysis. FEA derives its name from the manner in which the geometry of the object under consideration is specified. With the advent of the modern digital computer, FEA has been implemented as FEA software. Basically, the FEA software is provided with a model of the geometric description and the associated material properties at each point within the model. In this model, the geometry of the system under analysis is represented by solids, shells and beams of various sizes, which are called elements. The vertices of the elements are referred to as nodes. The model is comprised of a finite number of elements, which are assigned a material name to associate with material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

The implicit finite element analysis (“the implicit method”) and the explicit finite element analysis (“the explicit method”) are two methods in FEA. Both methods are used to solve transient dynamic equations of motion and thus obtain an equilibrium solution to the equations. The methods march from time t through a discrete time interval or time interval or time step Δt. Such methods are sometimes referred to as time-marching engineering simulation.

The present invention relates to the explicit method, which is stable only if time step Δt is very small—specifically, the time interval must be smaller than the time taken for an elastic wave to propagate from one side of an element to the other. The maximum time step for maintaining a stable solution in the explicit method is referred to as the critical time step size Δt_{cr}. The speed of the elastic wave is a function a material mass and stiffness of the structure represented by the finite element and the element size or dimension. For a FEA model having substantially similar material, the smallest element generally controls the critical time step size. One of the problems is that one substantially smaller element in a FEA model can cause the critical time step size unnecessarily small for majority of the elements in the FEA model. For example, a smallest element is one order of magnitude (e.g., 10 times) smaller than the rest. The resulting critical time step size is 10 times smaller than necessary thereby requiring 10 times of computation resources (i.e., processing time, storage) not mentioning wasted man hours to perform an engineering simulation.

To overcome the problem, a procedure called mass scaling is used. Mass scaling artificially increases the mass of the system thereby increase the critical time step size. However, mass scaling alters the dynamic characteristics of the system (i.e., finite element analysis model). As a result, the simulation may not be correct any more. It is therefore desirable to have an improved technique of applying mass scaling in finite element analysis with less impact on numerically simulated dynamic characteristics of a product.

### SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses a system, method and software product for applying mass scaling in finite element analysis. According to one exemplary embodiment of the present invention, a finite element analysis (FEA) model is defined by a user and received in a computer system having a finite element analysis application module installed thereon. The FEA model comprises a plurality of nodes and elements, and material associated with each element. A critical time step size can be calculated from the information in the FEA model (e.g., element mass, size, etc.). Stable solution can be obtained in a time-marching engineering simulation using explicit FEA when the critical time step size is used. Critical time step size can be calculated using Eq. (4) in the “DETAILED DESCRIPTION” section below.

User can simply increase the mass density of the materials such that the entire structure would become numerically heavier thereby resulting in a larger critical time step size. Increasing overall material density can be generally done in a trial-and-error basis, in which the user can eventually find a fictitious mass density that produces a decent critical time step hence obtaining a stable solution of time-marching engineering simulation within a reasonable turnaround time (real time for engineers/scientists who design the product).

If, however, user chooses to specify a desired time step size in the FEA model definition, the desired time step size is compared with the critical time step size. No mass scaling is required when the desired time step size is smaller than or equal to the critical time step size. Otherwise, mass scaling is applied to the FEA model by the application module automatically.

According to one aspect of the present invention, all finite elements are checked for mass scaling. Using element properties such as geometry and material properties, all elements having their critical time step falls below the desired time step are identified. These elements would need extra mass to prevent the numerical simulation from going unstable. Out of these elements, elements located in a particular region requiring realistic simulated dynamic responses are processed with selective mass scaling (new improved technique) and the rest are processed with regular mass scaling (prior art traditional technique). The aforementioned method is referred to as a mixed mode mass scaling.

According to another aspect of the invention, the application module applies numerical added masses in accordance with the new improved technique to both translational and rotational masses at each node of a shell finite element in the region that require realistic dynamic structural behaviors. The new improved technique (selective mass scaling) includes adding fictitious numerical added masses to the diagonal terms, and adding correctional values at the cross-coupling off-diagonal terms of the mass matrix of the shell element of interest. The correctional values are configured for reducing the impact to simulated dynamic characteristics caused by both translational and rotational rigid body modes of said shell element.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a function diagram showing salient components of an exemplary computer, in which one embodiment of the present invention may be implemented;

FIG. 2 is a block diagram showing exemplary application modules;

FIG. 3 is a diagram showing a diagonal mass matrix and corresponding acceleration vector for an exemplary quadrilateral shell element, in which regular mass scaling can be applied;

FIG. 4 is a diagram showing an exemplary mass matrix with selective mass scaling for translational rigid body mode of a quadrilateral shell element;

FIG. 5A and FIG. 5B collectively show a flowchart illustrating an exemplary process of applying mass scaling in an explicit finite element analysis, according to an embodiment of the present invention;

FIG. 6 is a two-dimensional view showing an exemplary finite element mesh (i.e., a rectangular grid) containing a small region that requires detailed structure responses, the selective mass scaling can be applied to such region in accordance with one embodiment of the present invention;

FIG. 7 shows two exemplary relatively small components of a relatively large structure—an automobile, in which a mixed mode mass scaling can be applied in an explicit finite element analysis;

FIG. 8 shows exemplary translational and rotational rigid body modes in accordance with one embodiment of the present invention; and

FIG. 9 lists equations used for applying selection mass scaling that includes rotational masses in accordance with one embodiment of the present invention.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

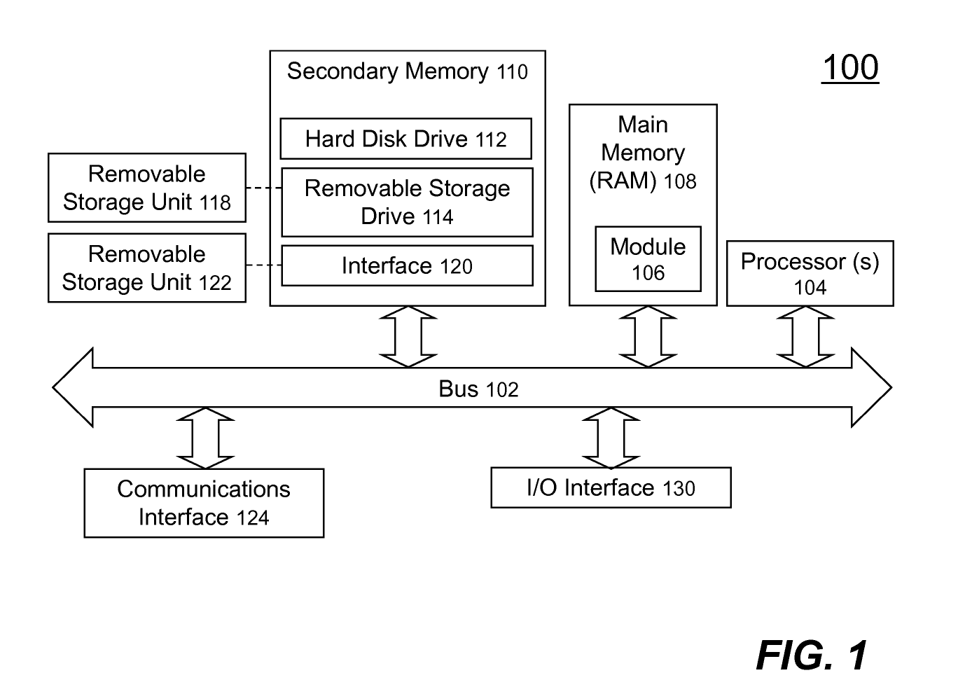

Embodiments of the present invention are discussed herein with reference to FIGS. 1-9. However, those skilled in the art will readily appreciate that the detailed description given herein with respect to these figures is for explanatory purposes as the invention extends beyond these limited embodiments.

Referring now to the drawings, in which like numerals refer to like parts throughout several views. The present invention may be implemented using hardware, software or a combination thereof and may be implemented in a computer system or other processing system. According to one embodiment, the invention is directed towards one or more computer systems capable of carrying out the functionality described herein. An example of a computer system 100 is shown in FIG. 1. The computer system 100 includes one or more processors, such as processor 104. The processor 104 is connected to a computer system internal communication bus 102. Various software embodiments are described in terms of this exemplary computer system. After reading this description, it will become apparent to a person skilled in the relevant art(s) how to implement the invention using other computer systems and/or computer architectures.

Computer system 100 also includes a main memory 108, preferably random access memory (RAM), and may also include a secondary memory 110. The secondary memory 110 may include, for example, one or more hard disk drives 112 and/or one or more removable storage drives 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc. which is read by and written to by removable storage drive 114. As will be appreciated, the removable storage unit 118 includes a computer usable storage medium having stored therein computer software and/or data.

In alternative embodiments, secondary memory 110 may include other similar means for allowing computer programs or other instructions to be loaded into computer system 100. Such means may include, for example, a removable storage unit 122 and an interface 120. Examples of such may include a program cartridge and cartridge interface (such as that found in video game devices), a removable memory chip (such as an EPROM, universal serial bus USB flash memory, or PROM) and associated socket, and other removable storage units 122 and interfaces 120 which allow software and data to be transferred from the removable storage unit 122 to computer system 100. In general, Computer system 100 is controlled and coordinated by operating system (OS) software, which performs tasks such as process scheduling, memory management, networking and I/O services.

There may also be a communications interface 124 connecting to the bus 102. Communications interface 124 allows software and data to be transferred between computer system 100 and external devices. Examples of communications interface 124 may include a modem, a network interface (such as an Ethernet card), a communications port, a PCMCIA slot and card, etc.

The computer 100 communicates with other computing devices over a data network based on a special set of rules (i.e., a protocol). One of the common protocols is TCP/IP (Transmission Control Protocol/Internet Protocol) commonly used in the Internet. In general, the communication interface 124 manages the assembling of a data file into smaller packets that are transmitted over the data network or reassembles received packets into the original data file. In addition, the communication interface 124 handles the address part of each packet so that it gets to the right destination or intercepts packets destined for the computer 100.

In this document, the terms “computer program medium” and “computer recordable storage medium” are used to generally refer to media such as removable storage drive 114 and a hard disk installed in hard disk drive 112. These computer program products are means for providing software to computer system 100. The invention is directed to such computer program products.

The computer system 100 may also include an I/O interface 130, which provides the computer system 100 to access monitor, keyboard, mouse, printer, scanner, plotter, and alike.

Computer programs (also called computer control logic) are stored as application modules 106 in main memory 108 and/or secondary memory 110. Computer programs may also be received via communications interface 124. Such computer programs, when executed, enable the computer system 100 to perform the features of the present invention as discussed herein. In particular, the computer programs, when executed, enable the processor 104 to perform features of the present invention. Accordingly, such computer programs represent controllers of the computer system 100.

In an embodiment where the invention is implemented using software, the software may be stored in a computer program product and loaded into computer system 100 using removable storage drive 114, hard drive 112, or communications interface 124. The application module 106, when executed by the processor 104, causes the processor 104 to perform the functions of the invention as described herein.

The main memory 108 may be loaded with one or more application modules 106 that can be executed by one or more processors 104 with or without a user input through the I/O interface 130 to achieve desired tasks. In operation, when at least one processor 104 executes one of the application modules 106, the results are computed and stored in the secondary memory 110 (i.e., hard disk drive 112). The status of the finite element analysis is reported to the user via the I/O interface 130 either in a text or in a graphical representation.

In one embodiment, an application module 106 is configured to facilitate the creation of a finite element analysis model to represent a structure to be simulated. The application module 106 allows users (e.g., engineers, scientists, etc.) to define a desired time step. In another embodiment, the application module 106 is configured to facilitate the calculation of the required added mass to stabilize the explicit method to achieve desired time step size.

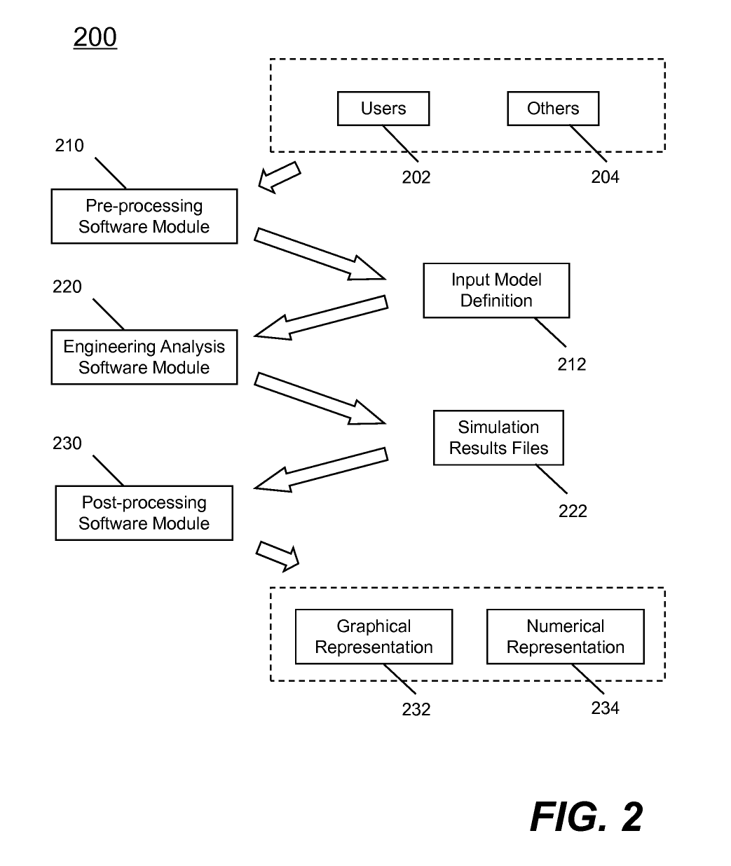

FIG. 2 is a functional block diagram 200 of exemplary software application modules in accordance with one embodiment of the present invention. In general, an engineering analysis simulation employs a pre-processing software module 210 runs on a computing device (e.g., 100 of FIG. 1). The pre-processing module 210 receives inputs from users 202 and other software packages 204 (e.g., a computer-aided-design software, an input conversion software, etc.). The pre-processing module 210 generally allows interactive activities for users 202, such that the input model definition 212 can be created efficiently with visual inspection. The input model definition 212 is the result or output of the pre-processing software module 210 to be used by the engineering analysis module 220 as input. In one embodiment, the analysis module 220 is configured to facilitate the calculation of the required added mass to maintain stability in the explicit method. The output of the analysis module 220 is the simulation results file or files 222, which contains numerical data in general. The post-processing software module 230 is then used to receive the numerical results from the simulation results files 222 and to display the numerical results in graphical 232 or numerical representation 234 as appropriated. The post-processing module 230 enables users to review the simulation results visually.

In an explicit finite element analysis, the equation of motions of an undamped system (e.g., a structure) is listed as follows:

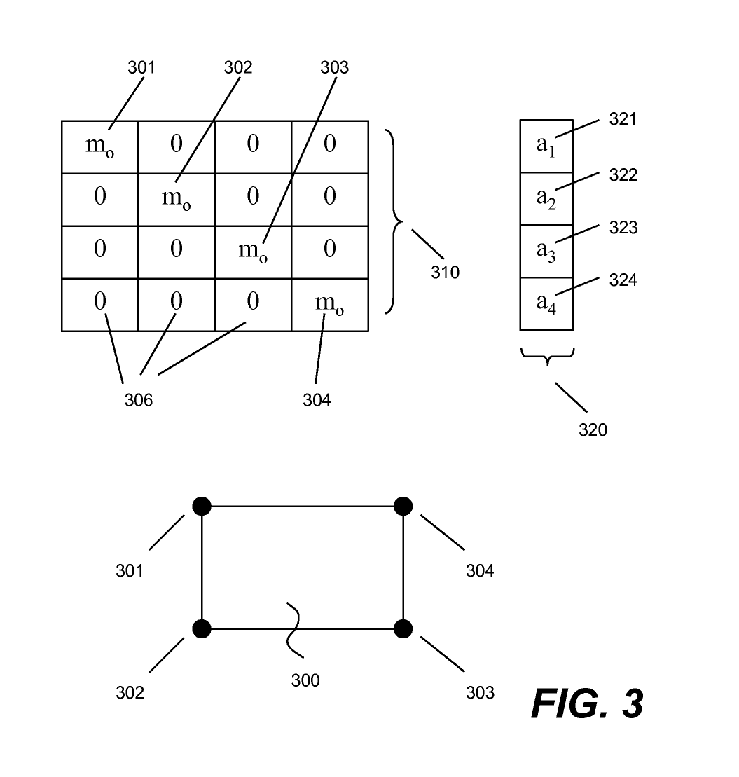

a=M⁻¹(fₑₓₜ−fᵢₙₜ) (1)

where a is the unknown acceleration vector representing nodal accelerations, M is a lumped, diagonal, matrix with zeros in the off-diagonal terms, and fₑₓₜ and fᵢₙₜ are the external applied forces and the internal nodal forces, respectively. The force term fₑₓₜ−fᵢₙₜ is referred to as the residual forces including, but not limited to, applied loads, contact forces, internal stresses. Because M has only diagonal terms, computation of M⁻¹ can simply be performed as a division instead of costly matrix inversion. FIG. 3 shows a diagonal mass matrix 310 and corresponding acceleration vector 320 for an exemplary 4-node shell element 300. In this exemplary mass matrix 310, each of the four nodes has the same amount of mass represented by the diagonal term mₒ (e.g., lumped nodal mass 301, 302, 303, or 304). All of the off-diagonal terms 306 are zeros. The acceleration vector 320 includes the acceleration at each of the nodes (i.e., a₁ 321, a₂ 322, a₃ 323, and a₄ 324). The inertia force for each of the nodes is calculated with the diagonal terms multiplying the corresponding acceleration as follows:

$${f}_{i} = {\sum }_{j = 1 , N} {m}_{ij} {a}_{j} \\ i = 1 , N \qquad ( 2 )$$

where N is the number of nodes in the element. N is equal to 4 for a quadrilateral shell element and 8 for a hexahedral solid element. The inertia forces at four nodes of the element 300 are calculated in accordance with Equation (2) as follows:

f₁=mₒa₁+(0)a₂+(0)a₃+(0)a₄=mₒa₁

f₂=(0)a₁+mₒa₂+(0)a₃+(0)a₄=mₒa₂

f₃=(0)a₁+(0)a₂+mₒa₃+(0)a₄=mₒa₃

f₄=(0)a₁+(0)a₂+(0)a₃+mₒa₄=mₒa₄ (3)

In order to simplify the illustration and description, only one component at each node is shown in FIG. 3. In a Cartesian coordinate system, there are three translational masses at each node, hence total number of components is 12 (i.e., three times four).

Equation (1) is solved with an explicit method in time integration, which is performed with one time step at a time. The explicit method can only produce stable solution only if the time step size Δt is smaller than the critical value Δt_{cr}, which is determined by the following formula:

$$Δ {t}_{cr} = \frac{2}{{ω}_{max}} \qquad ( 4 )$$

ωₘₐₓ is the maximum eigenfrequency of the system. The eigenfrequencies can be obtained by solving the following eigenvalue problem:

det[K−ωᵢ²M]=0 (5)

where K and M are m×m stiffness and mass matrix of the system, respectively, and m is number of degrees of freedom of the system. The maximum eigenfrequency ωₘₐₓ is generally a large number (e.g., in the order of 10⁶ Hz), thus the critical time step size Δt_{cr} is a very small number (e.g., in the order of microseconds). This small time step limits the usefulness of the explicit method in simulating a quasi-static process such as metal forming

One way to increase the critical time step size is to decrease the maximum eigenfrequency ωₘₐₓ, which can be achieved by increasing the mass of the system. The present invention allows a user to specify a desired time step size Δt. The required mass to ensure stability of the explicit method can then be calculated as follows:

m=αk(Δt)² (6)

where m is the required mass, k is the stiffness and α is a constant that depends on the specific integration scheme. In a finite element analysis model, each of the elements has a stiffness that depends on the geometry and material properties. Hence, the required mass may be computed using Equation (6) for each of the elements at each solution cycle. The critical time step size is a function of the square root of the mass, thus a much larger mass is required to increase the critical time step. The required mass is also referred to as the added mass hereinafter, and mass scaling is referred to the procedure to modify the real mass of a system with the added mass.

Mass scaling can be applied with a number of techniques. One of the most basic approaches is to change material mass density of the entire structure in a trial-and-error manner. Such procedure can generally be performed by users of the FEA without any automated computation, and the FEA solution could be obtained with a suitable material mass density after several material mass density adjustments.

Automated procedure is implemented in an application module (e.g., FEA software). Generally, a desired time step size is specified by the user of the FEA, the application module comprises certain logics or subprograms that would calculate a factor to increase the mass density automatically such that the desired time step size can be used in the engineering simulation to obtain a solution. The automated procedure can be carried out in an element-by-element basis. For each element in a FEA model, a critical time step size can be calculated based on element's mass and geometry. Based on Equation (4), the critical time step size Δt_{cr} can be increased by decreasing the maximum eigenfrequency, which is equivalent to increasing the mass of an otherwise unaltered element.

If a particular element's critical time step size is smaller than the desired time step size, an added mass can be calculated and added to the particular element to ensure the critical time step size of that element would become at least as large as the desired time step size. Some of the elements may not require any added mass when the critical time step size of those elements is larger or equal to the desired time step size.

A first automated approach is referred to as regular or conventionally mass scaling. The regular mass scaling is an improvement over the trial-and-error manual mass density adjustment, because added mass is automatically calculated and added to the diagonal terms of the mass matrix (see FIG. 3). The regular mass scaling can be performed relatively fast because it is very straight forward to calculate added mass, which is a function of the desired time step size, critical time step size and each element's material and geometric properties. However, the regular mass scaling adds spurious dynamic effects in entire frequency spectrum as added masses are added to a number of elements throughout the system. Adding spurious dynamic effects results into altered dynamic characteristics of the system, which may be undesirable, in particular, for those areas or regions desirous of realistic dynamic structural responses in an engineering simulation.

Because dynamic structural responses are generally contributed more from low frequency than the high frequency portion of the spectrum, another or a second mass scaling technique referred to as selective mass scaling is developed, which allows the mass scaling affecting the higher frequency dynamic characteristics more than the lower frequency ones. The selective mass scaling may be applied in conjunction with the regular mass scaling technique. The selective mass scaling technique modifies not only the diagonal terms of the mass matrix, but also the off-diagonal terms. The following equations define the diagonal and off-diagonal terms in the selective mass scaling:

mᵢᵢ=m+mₒ

mᵢⱼ=−m/(N−1)

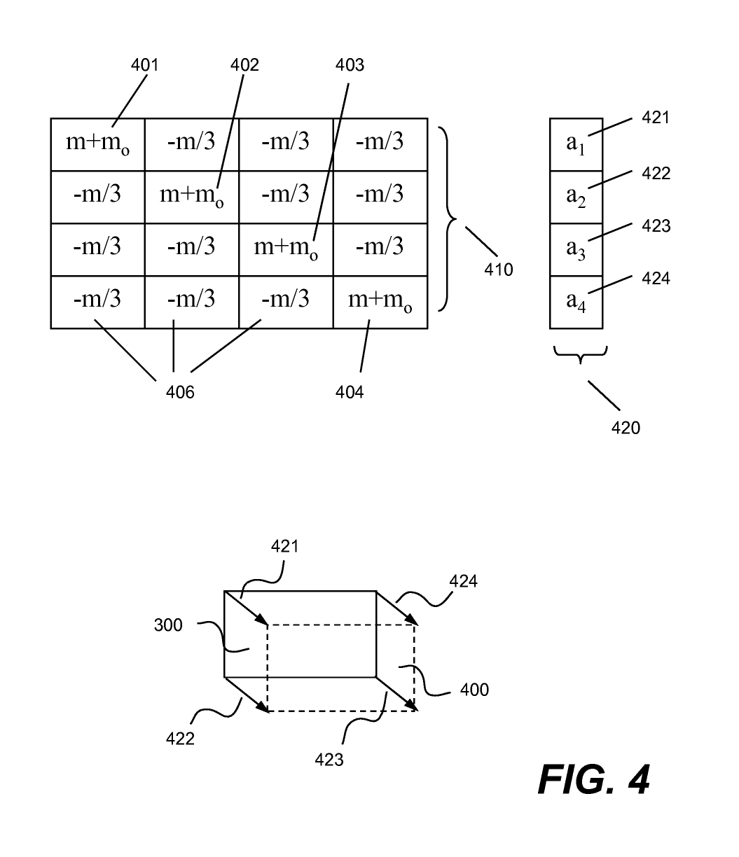

i,jε[1,N] (7)

where N is number of nodes in the element, m is the added mass calculated from Equation (6) and mₒ is the original lumped nodal mass of the system. An exemplary element mass matrix 410 with mass scaling using the selective mass scaling technique for a 4-node shell element (e.g., element 300 of FIG. 3) is listed in FIG. 4. The diagonal terms 401, 402, 403, and 404 are set to the added mass calculated using Equation (6) plus the original lumped mass for the shell element 300. The magnitude of off-diagonal terms “(−m/3)” 406 is set to be negative one (N−1)th of that of the diagonal term as the element 300 has four nodes.

The inertia force at each of the nodes can be calculated in accordance with Equation (2) using the mass matrix defined with Equation (7) as follows:

f₁=(m+mₒ)a₁+(−m/3)a₂+(−m/3)a₃+(−m/3)a₄

f₂=(−m/3)a₁+(m+mₒ)a₂+(−m/3)a₃+(−m/x3)a₄

f₃=(−m/3)a₁+(−m/3)a₂+(m+mₒ)a₃+(−m/3)a₄

f₄=(−m/3)a₁+(−m/3)a₂+(−m/3)a₃+(m+mₒ)a₄ (8)

The off-diagonal terms 406 in the selective mass scaling technique are designed to cancel the artificial inertia force caused by the diagonal terms for the rigid body modes of the element 300. The lowest frequency mode of an exemplary shell element 300 is a rigid body mode 400 as shown in FIG. 4. The shape of the shell element 300 does not change in a translational rigid body mode 400, thus the nodal displacement at each of the four nodes has the same magnitude. So are the nodal accelerations included in an acceleration vector 420. In other word, the node nodal acceleration a₁ 421, a₂ 422, a₃ 423, and a₄ 424 are equal to one another. The inertia force for each of the four nodes in a translational rigid body mode is calculated in accordance with Equation (2) as follows:

a₁=a₂=a₃=a₄=a

f₁=(m+mₒ)a+(−m/3)a+(−m/3)a+(−m/3)a=mₒa

f₂=(−m/3)a+(m+mₒ)a+(−m/3)a+(−m/3)a=mₒa

f₃=(−m/3)a+(−m/3)a+(m+mₒ)a+(−m/3)a=mₒa

f₄=(−m/3)a+(−m/3)a+(−m/3)a+(m+mₒ)a=mₒa (9)

It is evident that the selective mass scaling technique fulfills the objective of increasing the maximum eigenfrequency ωₘₐₓ, while maintaining the rigid body modes (i.e., the lowest eigenfrequency) of the system. However, the amount of computations for the selective mass scaling is much larger than that of the regular mass scaling.

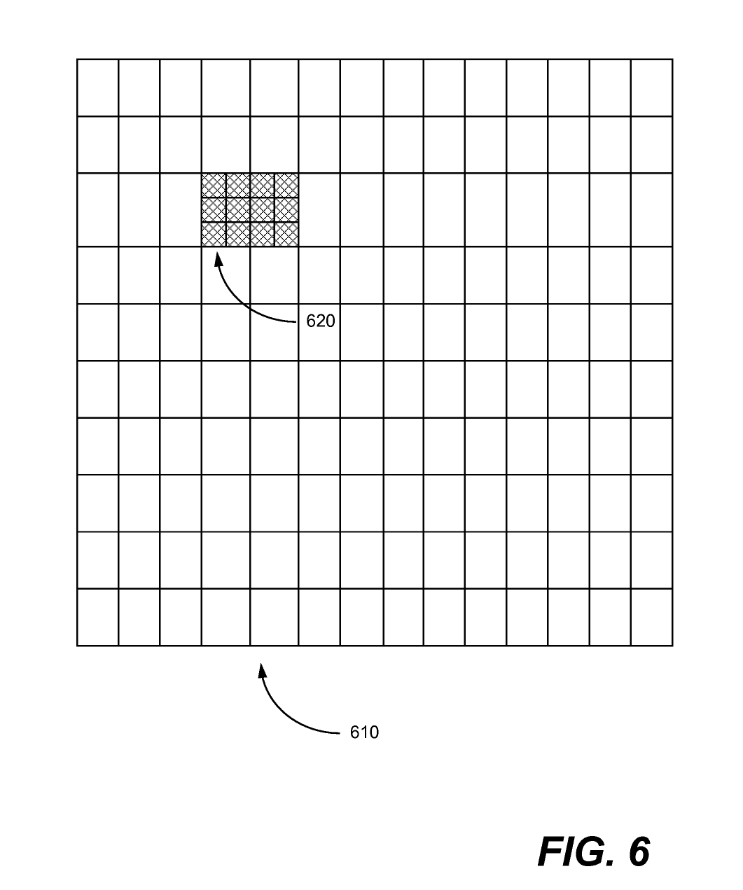

According to one embodiment of the present invention, a mixed mode mass scaling (i.e., the regular mass scaling technique and the selective mass scaling technique alone or in combination) can be used. In particular, the mixed mode mass scaling is used for simulating a relatively large engineering product or structure containing a relatively small region that requires detailed dynamic structural responses. FIG. 6 is a simplified two-dimensional diagram showing an exemplary two-dimensional finite element model 610 having a relatively small region 620 (shaded area) with a relatively finer finite element mesh. Due to the relatively small dimension of those elements in the small region 620, a substantially small time step is resulted thereby requiring long turnaround time (i.e., real time for a computer system to perform the simulation). Applying selective mass scaling to those elements in the small region 620 can increase the critical time step size while maintaining physically more realistic dynamic structural responses than just applying regular mass scaling throughout the entire FEA model. For illustration simplicity, a two-dimensional finite element mesh is shown. Those ordinary skilled in art would know any arbitrary three-dimensional finite element model can be shown in FIG. 6.

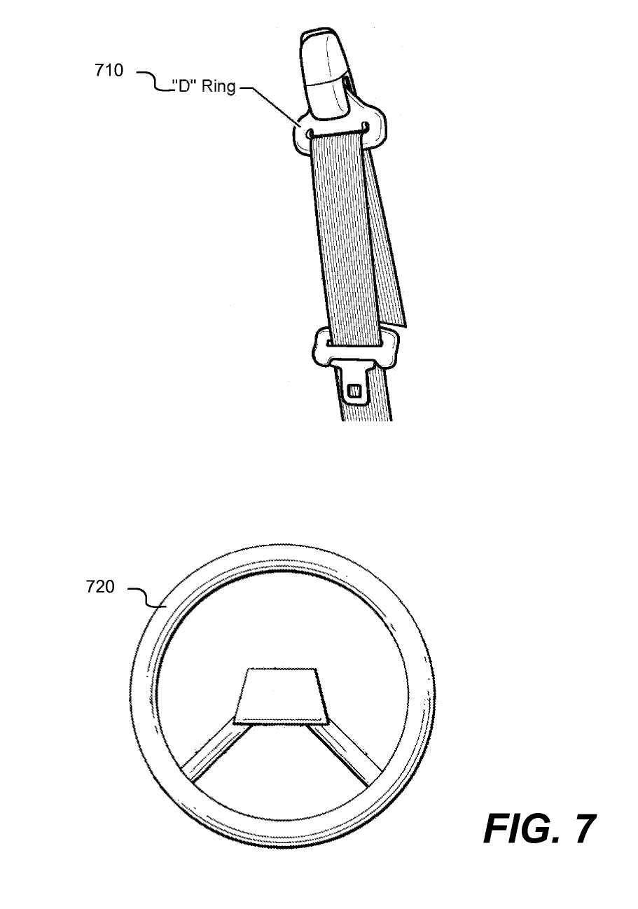

Using real world examples to show such situation in FIG. 7, an automobile is the relatively large structure, while the steering wheel 710 or the “D-Ring” 720 of a seat belt is the relatively small region.

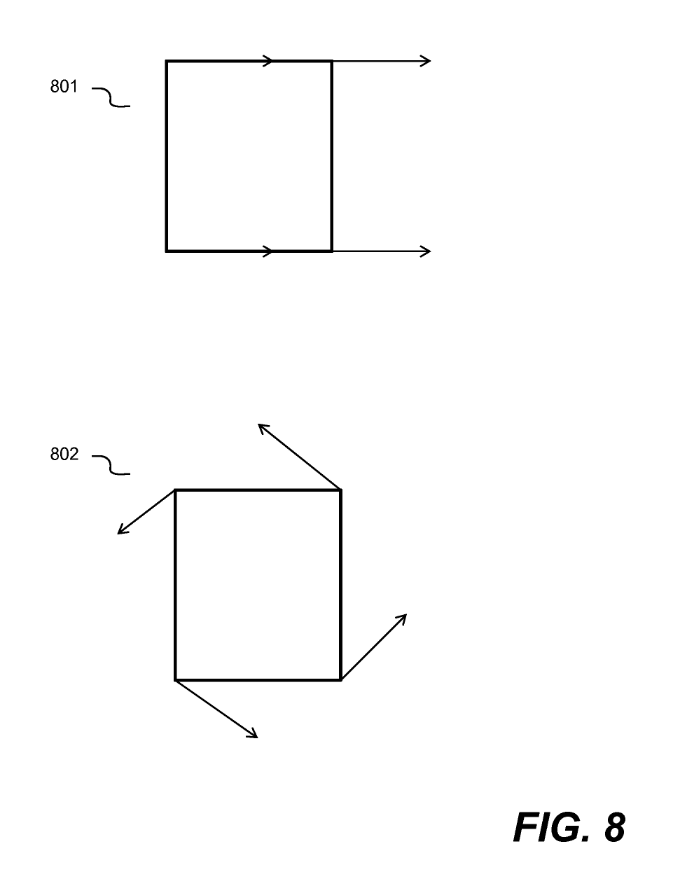

According to the above-described embodiment, impacts due to translational rigid body modes of a shell element are reduced. In real world, the product may experience rotational motions. FIG. 8 shows an exemplary shell finite element under respective translational 801 and rotational modes 802. In order to reduce the impact due to rotational motions, rotational rigid body modes are included in the technique of applying selective added mass, according to another embodiment of the present invention.

In the embodiment that include rotational rigid body modes, the mass matrix M of an exemplary 4-noded shell finite element is listed below:

$$M = ( \begin{matrix}m & & & \\ & m & & \\ & & m & \\ & & & m\end{matrix} ) \\ where \\ m = ( \begin{matrix}{m}_{t} I & \\ & {m}_{r} I\end{matrix} ) \qquad ( 10 )$$

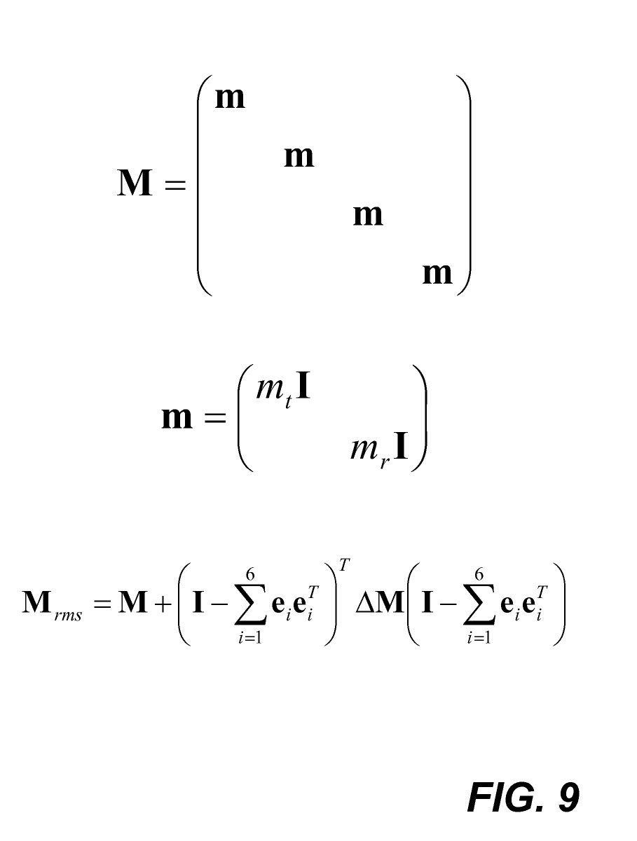

and mₜ is translational mass, mᵣ is rotational mass and I is a 3×3 identity matrix. For each shell element, there are 3 translational masses and 3 rotational masses at each node for a total 24 terms in the mass matrix M. (see FIG. 9)

To not affect rotational rigid body motions when applying selective mass scaling, the following descriptions provide mathematical derivations.

For any given arbitrary rigid body velocity motion represented by the translational velocity v and rotational velocity ω, the nodal velocities at node i are given by:

vᵢ=v+ω×(xⁱ−x)

ωⁱ=ω
i=1, 2, 3 or 4
   For simplicity we take

$$x = \frac{1}{4} ( {x}^{1} + {x}^{2} + {x}^{3} + {x}^{4} )$$

to be coordinate of the center of the shell element. This means that the rigid body velocity and rotational velocity is with respect to this coordinate.

This can be rewritten as follows:

$$( \begin{matrix}{v}^{i} \\ {ω}^{i}\end{matrix} ) = ( \begin{matrix}I & {R}^{i} \\ 0 & I\end{matrix} ) ( \begin{matrix}v \\ ω\end{matrix} ) \\ where \\ {R}^{i} = ( \begin{matrix}0 & {x}_{3}^{i} - {x}_{3} & - {x}_{2}^{i} + {x}_{2} \\ - {x}_{3}^{i} + {x}_{3} & 0 & {x}_{1}^{i} - {x}_{1} \\ {x}_{2}^{i} - {x}_{2} & - {x}_{1}^{i} + {x}_{1} & 0\end{matrix} ) \qquad ( 12 )$$

and subscript of x represents three translational dimensions at respective nodes in a three-dimensional space.

A nodal rigid body velocity vector can therefore be written as:

$$( \begin{matrix}I & {R}^{1} \\ 0 & I \\ I & {R}^{2} \\ 0 & I \\ I & {R}^{3} \\ 0 & I \\ I & {R}^{4} \\ 0 & I\end{matrix} ) ( \begin{matrix}v \\ ω\end{matrix} ) \qquad ( 13 )$$

which spans a 6-dimensional subspace (i.e., three translational and three rotational rigid body modes).

Let e₁, e₂, . . . , e₆ be an orthonormal basis for this subspace. The rotational selective mass scaling mass matrix Mᵣₘₛ is then formed as

$${M}_{rms} = M + {( I - {\sum }_{i = 1}^{6} {e}_{i} {e}_{i}^{T} )}^{T} Δ M ( I - {\sum }_{i = 1}^{6} {e}_{i} {e}_{i}^{T} ) \qquad ( 14 )$$

where ΔM is added mass at each of the diagonal terms. Superscript T indicates a transpose of a matrix or vector. FIG. 9 shows Equations (10) and (14). An arbitrary rigid body velocity vector can be written as

$$v = {\sum }_{i = 1}^{6} {α}_{i} {e}_{i}$$

and thus

Mᵣₘₛv=Mv

In other words, the added mass does not contribute to the momentum for rigid body motion.

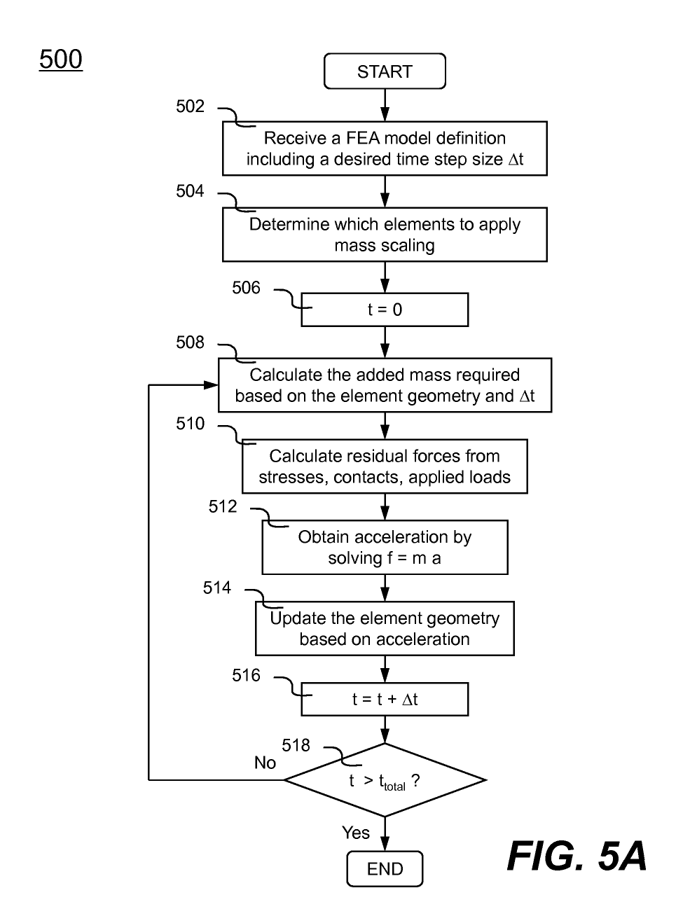

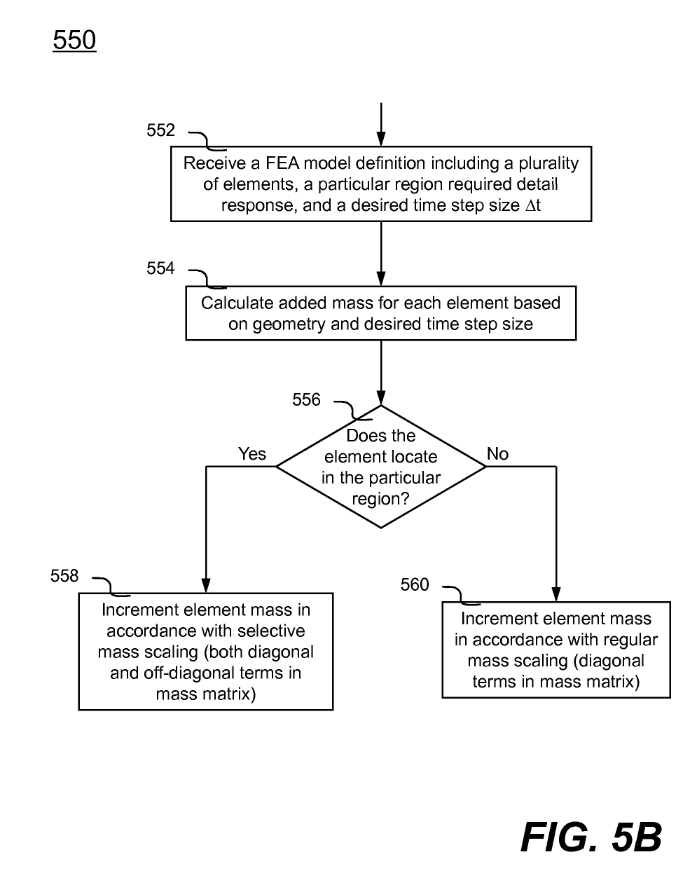

Referring now to FIG. 5A and FIG. 5B, there are collectively illustrated an exemplary process 500 of applying mass scaling in an explicit finite element analysis, which is used in an engineering simulation for assisting a user to make decision in improvement of an engineering product design, according to one embodiment of the present invention. Process 500 is preferably understood in conjunction with the previous figures especially FIGS. 3 and 4, and may be implemented in software.

Process 500 starts by receiving a definition of a finite element analysis (FEA) model, which represents an engineering product or structure (e.g., an automobile, an airplane, etc.) at step 502. The definition of the FEA model includes a desired time step size Δt. At step 504, process 500 determines which elements are chosen to apply mass scaling. The current simulation time t is set to zero at step 506. Process 500 starts the time history simulation at a first solution cycle at step 508 by calculating the added mass for each of the chosen elements in accordance with Equation (6). The stiffness of the element is a function of the current geometry and material properties of the element. The desired time step size Δt is defined by user. In one embodiment, an element mass matrix such as the exemplary mass matrix 410 as shown in FIG. 4 is created for each of the chosen elements. The element mass matrix includes both diagonal terms and non-zero off-diagonal terms. The off-diagonal terms are designed to offset fictitious inertia force from the diagonal terms in rigid body modes of the element. Process 500 calculates the residual forces f from the stresses, contacts and applied loads at step 510. At step 512, the acceleration a is then obtained by solving the following equation:

f=Ma (15)

where M represents a global mass matrix including all of the element mass matrixes. Because of the added off-diagonal terms, the matrix M is not a diagonal matrix any more. To solve Equation (15), several methods may be used including, but not limited to, inversion of M, factorization of M, and iteration scheme (e.g., conjugate gradient). Process 500 updates the geometry of all of the elements using the acceleration obtained in solving Equation (15) at step 514. The current simulation time t is then incremented by a time step size Δt at step 516. Process 500 moves to decision 518, in which the current simulation time t is compared with a pre-determined total simulation time. If the current simulation time is less than the total simulation time, process 500 follows the “No” branch back to step 508 to perform simulation in another solution cycle until decision 518 becomes true and process 500 ends.

Referring now to FIG. 5B, a mixed mode mass scaling process 550 is shown in accordance with one embodiment of the present invention. Process 550 starts at step 552 by receiving, in a computer system, a finite element analysis (FEA) model, a user desired time step size and a particular region where detailed structure responses are desired. The particular region is selected by the user based on an assumption that the region will possess a large fraction of the total increment of kinetic energy due to mass scaling. Large increment in kinetic energy is a combination of large added mass and large (rigid body) velocity/acceleration, typically occurring in (smaller) regions with very fine finite element mesh. One illustrative exemplary FEA model is shown in FIG. 6. The shaded area 620 represents the particular region selected by the user. Using automobile crash simulation as an example, the entire car can be represented as a FEA model (not shown), while the steering wheel 720 or a “D-Ring” 710 of the seat belt as the particular region.

Then, at step 554, all elements are checked for mass scaling by calculating added mass based on geometry, material properties and the user desired time step. Equation (6) can be used to accomplish this step. Next, at decision 556, each element is checked whether it is located within the user selected particular region. If “Yes”, process 550 moves to step 558. Selective mass scaling scheme is used for that element. For example shown in FIG. 4, element mass matrix includes diagonal and off-diagonal terms for not affecting translational rigid body motions are used. To not affect both translational and rotational rigid body motions, the selective added mass technique is applied using Equation (14) (see FIG. 9 also). Otherwise, process 550 goes to step 560. Regular mass scaling is applied (i.e., only diagonal terms in the element mass matrix as shown in FIG. 3).

Applying mixed mode mass scaling allows the simulation to be completed within a reasonable turnaround time (i.e., physical simulation time in a computer system) and maintains more realistic dynamic structural characteristics.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a quadrilateral shell element has been shown and described how selective mass scaling technique is accomplished, other elements can be used instead, for example, 8-node solid element. Furthermore, whereas the mixed mode mass scaling has been shown and described to include selective mass scaling and regular mass scaling. Other equivalent combinations can be used, for example, selective mass scaling and no mass scaling. Finally, for illustration simplicity, only one translational and one rotational rigid body mode are shown in FIG. 8, there are three translational and three rotational rigid body modes in reality. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A computer-implemented method of applying mass scaling in finite element analysis comprising:
receiving, in a computer system having a finite element analysis application module installed thereon, a desired time step size for a time-marching engineering simulation of a product and a definition of the product in form of a finite element analysis model that contains a plurality of shell finite elements, each of the shell elements having three translational and three rotational rigid body modes and associated masses at each node;
designating a particular region of the product desirous of detailed structural dynamic responses;
dividing the plurality of shell finite elements into first and second groups, the first group representing the particular region, while the second group representing remaining of the product;
applying a first mass scaling scheme to finite elements in the first group, wherein said first mass scaling scheme includes scaling up nodal translational and rotational masses of said finite elements of the first group, and creating a set of cross-coupling effects amongst said nodal translation and rotational masses such that simulated structural dynamic responses of said particular region are less altered than scaling up said nodal translational masses alone;
applying a second mass scaling scheme only to those finite elements in the second group requiring added mass to maintain a critical time step size that is larger than or equal to the desired time step size, wherein said second mass scaling scheme consists of scaling up translational masses of each node of each of said those finite elements in the second group; and
obtaining simulated structural responses of the product by conducting the time-marching engineering simulation in the computer system using the finite element analysis model that includes mass scaled finite elements of the first and second groups, wherein the simulated structural responses are used for assisting a user in making design decisions for improving the product.

2. The computer-implemented method of claim 1, wherein said applying the first mass scaling scheme further comprises creating an element mass matrix with diagonal terms and non-zero off-diagonal terms for said finite elements in the first group.

3. The computer-implemented method of claim 2, wherein said diagonal terms include three translational masses and three rotational masses at each node of each of said finite elements.

4. The computer-implemented method of claim 3, wherein said off-diagonal terms are calculated using a set of orthogonal basis in a 6-dimensional subspace corresponding to said three translational and three rotational rigid body modes of said each of said finite elements.

5. The computer-implemented method of claim 4, wherein said off-diagonal terms are calculated using equation
$${M}_{rms} = M + {( I - {\sum }_{i = 1}^{6} {e}_{i} {e}_{i}^{T} )}^{T} Δ M ( I - {\sum }_{i = 1}^{6} {e}_{i} {e}_{i}^{T} )$$
where:
Mᵣₘₛ is an element mass matrix created with the first mass scaling scheme,
M is an original unscaled element mass matrix,
ΔM is said nodal translational and rotational added masses,
I is an identity matrix,
eᵢ is the set of orthogonal basis.

6. A system for applying mass scaling in finite element analysis comprising:
a main memory for storing computer readable code for a finite element analysis application module;
at least one processor coupled to the main memory, said at least one processor executing the computer readable code in the main memory to cause the application module to perform operations by a method of:
receiving a desired time step size for a time-marching engineering simulation of a product and a definition of the product in form of a finite element analysis model that contains a plurality of shell finite elements, each of the shell elements having three translational and three rotational rigid body modes and associated masses at each node;
designating a particular region of the product desirous of detailed structural dynamic responses;
dividing the plurality of shell finite elements into first and second groups, the first group representing the particular region, while the second group representing remaining of the product;
applying a first mass scaling scheme to finite elements in the first group, wherein said first mass scaling scheme includes scaling up nodal translational and rotational masses of said finite elements of the first group, and creating a set of cross-coupling effects amongst said nodal translation and rotational masses such that simulated structural dynamic responses of said particular region are less altered than scaling up said nodal translational masses alone;
applying a second mass scaling scheme only to those finite elements in the second group requiring added mass to maintain a critical time step size that is larger than or equal to the desired time step size, wherein said second mass scaling scheme consists of scaling up translational masses of each node of each of said those finite elements in the second group; and
obtaining simulated structural responses of the product by conducting the time-marching engineering simulation in the computer system using the finite element analysis model that includes mass scaled finite elements of the first and second groups, wherein the simulated structural responses are used for assisting a user in making design decisions for improving the product.

7. The system of claim 6, wherein said applying the first mass scaling scheme further comprises creating an element mass matrix with diagonal terms and non-zero off-diagonal terms for said finite elements in the first group.

8. The system of claim 7, wherein said diagonal terms include three translational masses and three rotational masses at each node of each of said finite elements.

9. The system of claim 8, wherein said off-diagonal terms are calculated using a set of orthogonal basis in a 6-dimensional subspace corresponding to said three translational and three rotational rigid body modes of said each of said finite elements.

10. The system of claim 9, wherein said off-diagonal terms are calculated using equation
$${M}_{rms} = M + {( I - {\sum }_{i = 1}^{6} {e}_{i} {e}_{i}^{T} )}^{T} Δ M ( I - {\sum }_{i = 1}^{6} {e}_{i} {e}_{i}^{T} )$$
where:
Mᵣₘₛ is an element mass matrix created with the first mass scaling scheme,
M is an original unscaled element mass matrix,
ΔM is said nodal translational and rotational added masses,
I is an identity matrix,
eᵢ is the set of orthogonal basis.

11. A non-transitory computer recordable storage medium containing computer instructions for applying mass scaling in finite element analysis, said computer instructions when executed on a computer system cause the computer system to perform the steps of:
receiving, in a computer system having a finite element analysis application module installed thereon, a desired time step size for a time-marching engineering simulation of a product and a definition of the product in form of a finite element analysis model that contains a plurality of shell finite elements, each of the shell elements having three translational and three rotational rigid body modes and associated masses at each node;
designating a particular region of the product desirous of detailed structural dynamic responses;
dividing the plurality of shell finite elements into first and second groups, the first group representing the particular region, while the second group representing remaining of the product;
applying a first mass scaling scheme to finite elements in the first group, wherein said first mass scaling scheme includes scaling up nodal translational and rotational masses of said finite elements of the first group, and creating a set of cross-coupling effects amongst said nodal translation and rotational masses such that simulated structural dynamic responses of said particular region are less altered than scaling up said nodal translational masses alone;
applying a second mass scaling scheme only to those finite elements in the second group requiring added mass to maintain a critical time step size that is larger than or equal to the desired time step size, wherein said second mass scaling scheme consists of scaling up translational masses of each node of each of said those finite elements in the second group; and
obtaining simulated structural responses of the product by conducting the time-marching engineering simulation in the computer system using the finite element analysis model that includes mass scaled finite elements of the first and second groups, wherein the simulated structural responses are used for assisting a user in making design decisions for improving the product.

12. The non-transitory computer recordable storage medium of claim 11, wherein said applying the first mass scaling scheme further comprises creating an element mass matrix with diagonal terms and non-zero off-diagonal terms for said finite elements in the first group.

13. The non-transitory computer recordable storage medium of claim 12, wherein said diagonal terms include three translational masses and three rotational masses at each node of each of said finite elements.

14. The non-transitory computer recordable storage medium of claim 13, wherein said off-diagonal terms are calculated using a set of orthogonal basis in a 6-dimensional subspace corresponding to said three translational and three rotational rigid body modes of said each of said finite elements.

15. The non-transitory computer recordable storage medium of claim 14, wherein said off-diagonal terms are calculated using equation
$${M}_{rms} = M + {( I - {\sum }_{i = 1}^{6} {e}_{i} {e}_{i}^{T} )}^{T} Δ M ( I - {\sum }_{i = 1}^{6} {e}_{i} {e}_{i}^{T} )$$
where:
Mᵣₘₛ is an element mass matrix created with the first mass scaling scheme,
M is an original unscaled element mass matrix,
ΔM is said nodal translational and rotational added masses,
I is an identity matrix,
eᵢ is the set of orthogonal basis.
